(19) United States
(12) Patent Application Publication
(10) Pub. No.: US 2004/0158605 A1
(43) Pub. Date: Aug. 12, 2004

(54) Domain-wide reset agents

(75) Inventors: Linda Van Patten Benhase, Tucson, AZ (US); Michael Thomas Benhase, Tucson, AZ (US); Stella Chan, San Jose, CA (US); John Richard Paveza, Morgan Hill, CA (US); Richard Anthony Ripberger, Tucson, AZ (US); Michael Liang Tan, Union City, CA (US); Yan Xu, Tucson, AZ (US)

Correspondence Address: SWANSON & BRATSCHUN, LLC - IBM, 1745 SHEA CENTER DRIVE, SUITE 330, HIGHLANDS RANCH, CO, 80129, US

(73) Assignee: International Business Machines Corporation, Armonk, NY

(21) Appl. No.: 10/364,709

(22) Filed: Feb. 10, 2003

(51) Int. Cl. G06F 15/16

(52) U.S. Cl. 709/202

(57) ABSTRACT

A network domain includes a plurality of agents and a domain server, the domain server operable for automatically transmitting messages to the agents to reset the agents upon the occurrence of a critical event. Upon receipt of a restart command, each agent terminates executing processes and then restarts processes.

### TECHNICAL FIELD

The present invention relates generally to the field of domain networks and, in particular, to performing a domain-wide reset of all agents in a domain upon the occurrence of a critical event.

### BACKGROUND ART

A networked domain includes various agent devices interconnected through a local area network (LAN) or other network. The domain includes a domain server and may also include other servers; all servers in the domain are also considered agents. In an IBM Enterprise Storage System (“ESS”) network, each ESS comprises two agents (either or both of which may be servers), each of which is connected to a network. Local or remote operator consoles may be used by an operator to access a server.

Under certain circumstances (an “exception”), an agent is unable to communicate with the domain server. If the exception affects only one agent, the affected agent may easily be manually restarted by an operator. However, an event which has more widespread effects (a “critical event”) requires that the processes being executed on many or all of the agents in a domain be halted, the agents reconnected with the domain server and the processes restarted. Unplanned critical events include (but are not limited to) the loss or failure of the domain server, the loss or failure of a DNS server, or the loss or failure of a hub or other fundamental piece of hardware. Planned or scheduled critical events include (but are also not limited to) shutting a domain down for maintenance or an upgrade, performing an initial configuration operation, or restarting the domain to reclaim memory. As noted, all critical events require that agents detect the event, terminate executing processes, wait for the domain server to recover, re-register with the domain server and restart the processes. It may take several minutes for the domain to completely restore itself. One option has been for an operator to manually connect to each agent in the domain, restart the agent, then connect to the next agent. It will be appreciated that this, too, is a time consuming process as well as being labor intensive.

Consequently, there remains a need for a substantially automatic process for restarting all agents in a domain, thereby permitting normal operations to quickly and efficiently resume.

### SUMMARY OF THE INVENTION

The present invention provides system and method for automatically restarting each agent in a domain upon the occurrence of a critical event. In one embodiment, the method comprises receiving notice of a critical event; obtaining an IP address of each agent in the domain; transmitting a restart command to the IP address of each agent; upon receipt of the restart command, terminating executing processes on each agent; and upon termination of all processes on an agent, restarting processes on the agent.

The present invention further includes a network domain comprising agents and a domain server having a processor operable to execute instructions for automatically restarting the agents in a domain upon a critical event. The instructions include instructions for obtaining an IP address of each agent in the domain and transmitting a restart command to the IP address of each agent. The restart command includes instructions executable by an agent to, upon receipt of the restart command, terminate executing processes on the agent; and upon termination of all processes on the agent, restart processes on the agent.

The present invention further includes a domain server having a processor operable to execute instructions for automatically restarting all agents in a domain upon a critical event. The instructions include instructions for obtaining an IP address of each agent in domain and transmitting a restart command to the IP address of each agent. The restart command includes instructions executable by an agent to terminate executing processes on the agent and, upon termination of all processes on the agent, restart processes on the agent.

The present invention further includes a computer-readable storage medium containing instructions for automatically restarting the agents in a domain upon a critical event. The instructions include instructions for obtaining an IP address of each agent in the domain and transmitting a restart command to the IP address of each agent. The restart command includes instructions executable by an agent to, upon receipt of the restart command, terminate executing processes on the agent; and upon termination of all processes on the agent, restart processes on the agent

### BRIEF DESCRIPTION OF THE DRAWINGS

FIG. 1 is a block diagram of a network domain on which the present invention may be implemented;

FIG. 2 is a flow chart of the present invention;

FIG. 3 is a more detailed flow chart of a first module of the present invention;

FIG. 4 is a more detailed flow chart of a second module of the present invention;

FIG. 5 is a more detailed flow chart of a third module of the present invention; and

FIG. 6 is a more detailed flow chart of a fourth module of the present invention.

### DETAILED DESCRIPTION OF THE PREFERRED EMBODIMENT

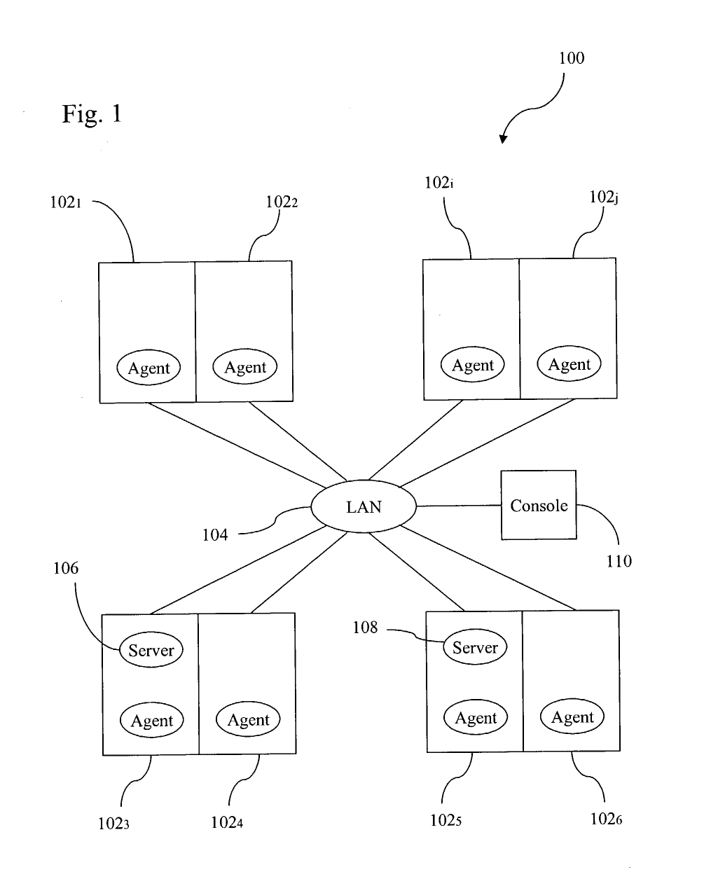

FIG. 1 is a block diagram of a network domain 100, such as an IBM ESS Copy Services Domain, on which the present invention may be implemented. Although the domain illustrated in FIG. 1 and described herein is an IBM ESS Copy Services Domain, the invention is not limited to such a domain but may be incorporated into other types of domains. The domain 100 includes numerous agents 102₁-102ⱼ. In the configuration illustrated, two agents reside in a single ESS unit. All of the agents 102 are interconnected through a network, such as a local area network 104. The domain 100 also includes a domain server 106, which is also an agent 102₃. Other servers 108 may also reside on the domain 100 (and are also agents). Operator or administrator access to agents and servers on the domain is through one or more consoles 110.

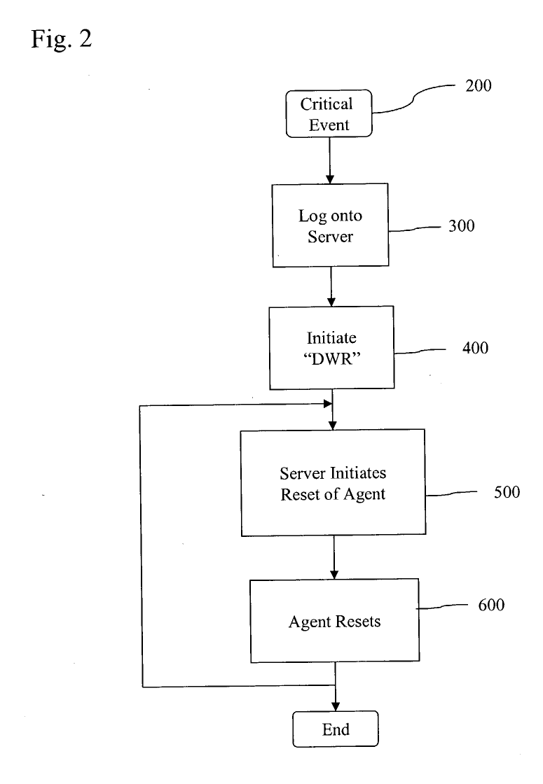

FIG. 2 is a high level flow chart of the present invention which may be implemented on the domain illustrated in FIG. 1. Upon the occurrence of a critical event (200), a system administrator at a console 110 logs onto a server 108 (300) and initiates a domain-wide reset command (400). Upon receipt of the reset command, the domain server 106 executes a resetting (500) of an agent 102 on the domain 100. Upon receipt of the domain server-transmitted reset command, the agent 102 resets (600), including reconnects to the domain server 106, and normal domain operations resume. The process repeats until all agents 102 have been reset.

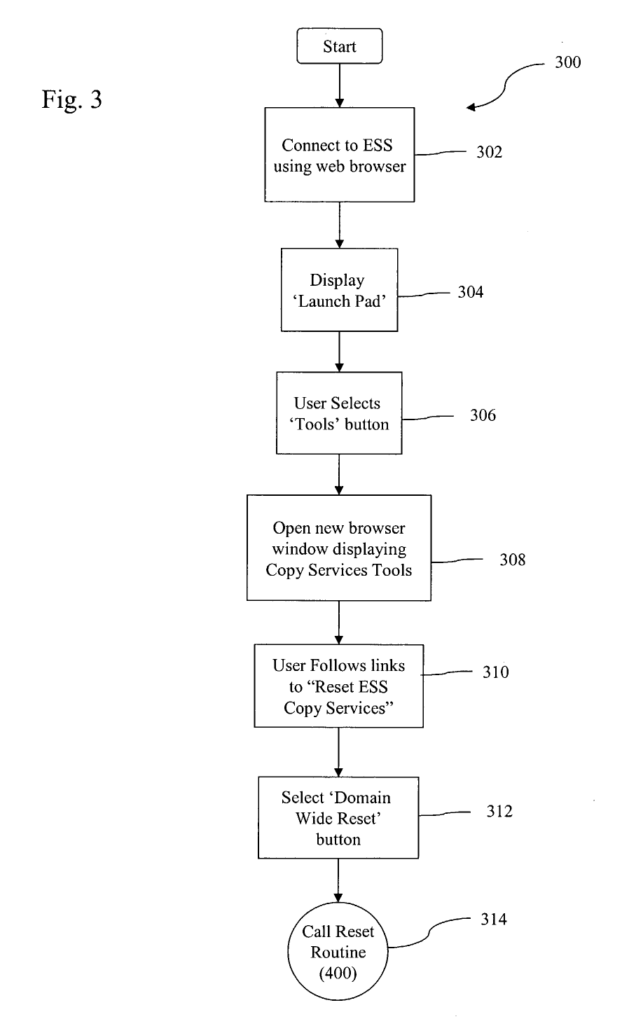

More particularly, referring now to FIG. 3, the system administrator connects to an ESS server 108 using a web browser open on a console display 110 (302), displaying a “launch pad” window (304). The administrator selects the “tools” option which causes a new window to open on the console 110 displaying “copy services tool” options (308). The administrator selects the displayed “reset ESS copy services” option (310) and, of the options then offered, selects the “domain wide reset” option (312) which transmits a “domain restart message” to the server 108 to which the administrator console 110 is connected (314).

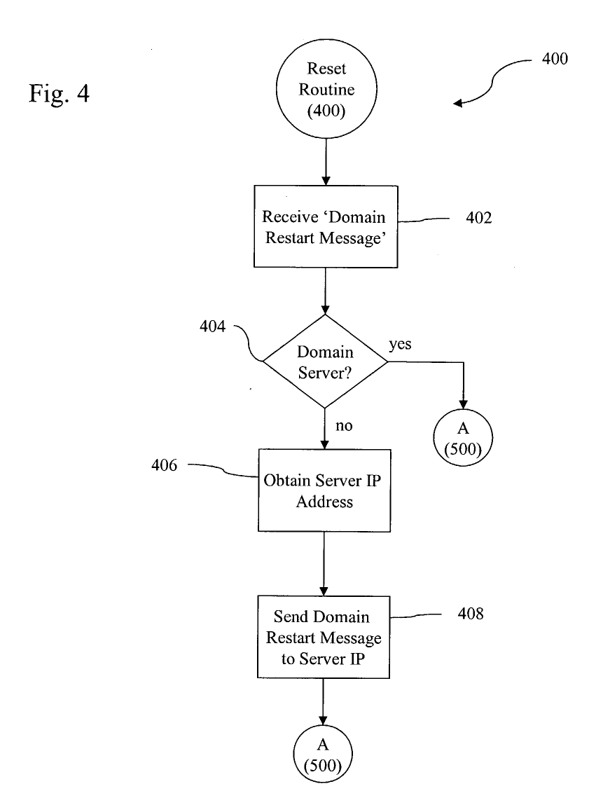

FIG. 4 is a flow chart representing instructions executed on the server 108 to which the administrator console 110 is connected. The current server 108 receives the “domain restart message” (402) and it is determined (404) whether the current server 108 is the domain server 106 by comparing the local IP address with the address of the domain server 106. If the current server 108 is the domain server 106, the actual reset routine is begun (500). Otherwise, the address of the domain server 106 is obtained (406) from a configuration file available on each ESS unit 102 and the “domain restart” message is then forwarded to the domain server 106 (408).

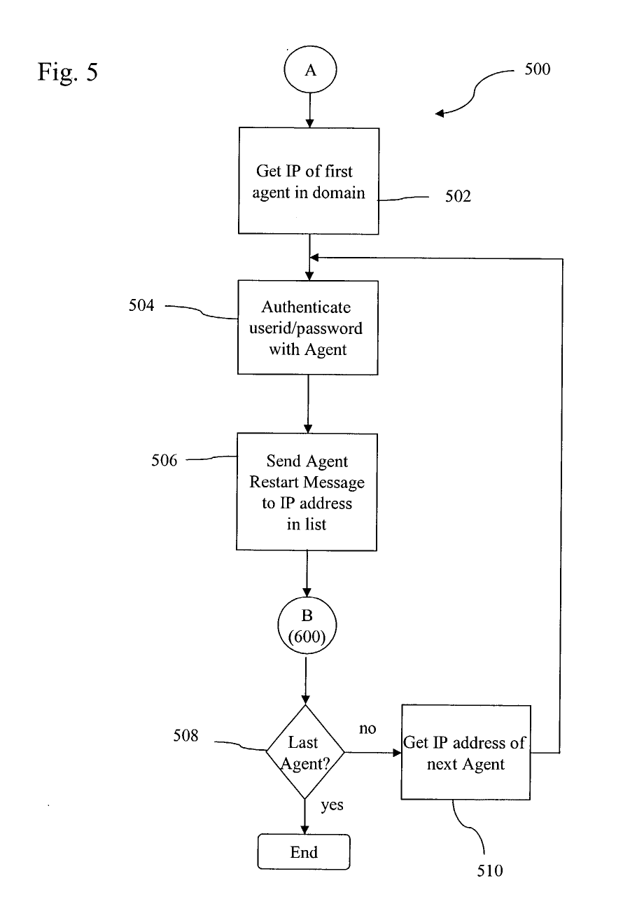

In either event, referring now to FIG. 5, the domain server 106 receives the “domain restart” message and obtains the IP address of an agent 102 from another configuration file located on each server 108 in the domain 100 (502). A connection with the agent 102 is established (504) and the domain server 106 transmits an “agent restart” message to the agent 102 (506). The process is repeated (508 and 510) until the “agent restart” message has been transmitted to all of the agents 102₁₋ⱼ in the domain 100, including the servers.

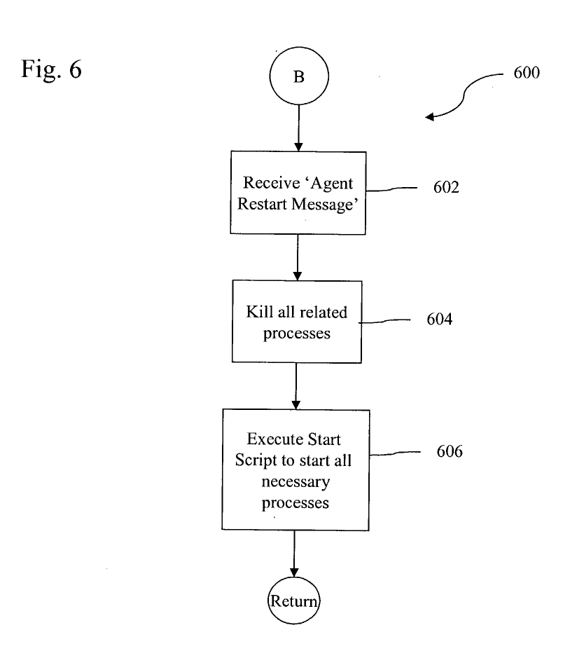

FIG. 6 is a flow chart representing instructions executed on each agent 102. Upon receipt by an agent 102 of the “agent restart” message (602), the agent 102 halts all relevant processes (604), such as agent processes, server processes and applets (if the agent is a server), “listener” processes, copy service processes and event notification processes, among others. After all the relevant processes have been halted, the agent 102 restarts all relevant processes, including reconnecting to the domain server 106 (606).

Consequently, by employing the domain wide restart system of the present invention, it is no longer necessary for an administrator to manually connect to each agent and restart each.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

What is claimed is:

1. A method for automatically resetting agents in a domain upon a critical event comprising:
receiving notice of a critical event;
obtaining an IP address of each agent in the domain;
transmitting a restart command to the IP address of each agent;
upon receipt of the restart command, terminating executing processes on each agent; and
upon termination of all processes on an agent, restarting processes on the agent.

2. The method of claim 1, wherein transmitting the restart command to the IP address of each agent comprises transmitting the restart command sequentially to the IP addresses of the agents.

3. A method for automatically resetting agents in a domain upon a critical event, the domain including a domain server, the method comprising:
receiving notice of a critical event;
establishing a connection with an agent server;
determining whether the agent server is the domain server;
if the agent server is not the domain server, obtaining the IP address of the domain server and transmitting a domain restart command to the domain server;
obtaining an IP address of each agent in the domain;
transmitting a restart command from domain server to the IP address of each agent;
upon receipt by an agent of the restart command, terminating executing processes on the agent; and
upon termination of all processes on the agent, restarting processes on the agent.

4. The method of claim 3, wherein transmitting the restart command to the IP address of each agent comprises transmitting the restart command sequentially to the IP addresses of the agents.

5. A computer-readable storage medium containing computer-executable instructions for:
obtaining the IP address of each agent in a domain; and
transmitting a restart command to the IP address of each agent;
the restart command initiating instructions executable by an agent to:
terminate executing processes on the agent; and
upon termination of all processes on the agent, restart processes on the agent.

6. The storage medium of claim 5, wherein transmitting restart command to the IP address of each agent comprises transmitting the restart command sequentially to the IP addresses of the agents.

7. A network domain, comprising:
a plurality of agents; and
a domain server comprising a processor operable to execute instructions for:
obtaining an IP address of each agent in domain; and
transmitting a restart command to the IP address of each agent;
the restart command initiating instructions executable by an agent to:
terminate executing processes on the agent; and
upon termination of all processes on the agent, restart processes on the agent.

8. The network domain of claim 7, wherein the instructions to transmit restart command to the IP address of each agent comprises instructions to transmit restart command sequentially to the IP addresses of the agents.

9. A domain server for a network having a plurality of agents, the domain server comprising:
a processor operable to execute instructions for:
obtaining an IP address of each agent in domain; and
transmitting a restart command to the IP address of each agent;
the restart command initiating instructions executable by an agent to:
terminate executing processes on the agent; and
upon termination of all processes on the agent, restart processes on the agent.

10. The domain server of claim 9, wherein the instructions to transmit restart command to the IP address of each agent comprises instructions to transmit restart command sequentially to the IP addresses of the agents.
